(19) United States
(12) Patent Application Publication
(10) Pub. No.: US 2024/0160914 A1
(43) Pub. Date: May 16, 2024

(54) CONTRASTIVE CREDIBILITY PROPAGATION FOR SEMI-SUPERVISED LEARNING

(71) Applicant: Palo Alto Networks, Inc., Santa Clara, CA (US)

(72) Inventors: Brody James Kutt, Santa Clara, CA (US); William Redington Hewlett, II, Mountain View, CA (US)

(21) Appl. No.: 18/052,140

(22) Filed: Nov. 2, 2022

(51) Int. Cl. G06N 3/08; G06F 18/214; G06F 18/2431; G06N 3/045

(52) U.S. Cl. CPC G06N 3/08; G06F 18/2155; G06F 18/2431; G06N 3/045

(57) ABSTRACT

A contrastive credibility propagation trainer (“trainer”) trains a representation neural network to learn credibility vectors for partially labeled data samples that represent certainty of samples belonging to each of a set of classes. The representation neural network is trained according to a loss function that accounts for both the credibility vectors and similarity of representations generated by the neural network itself. Using the credibility vectors as soft labels, the trainer trains a classifier neural network to generate labels for unlabeled samples in the partially labeled samples.

### BACKGROUND

The disclosure generally relates to computing arrangements based on specific computation models (e.g., CPC G06N) and using neural network models (e.g., CPC G06N3/04).

Semi-supervised learning is a machine learning task that involves using a subset of labeled samples to label a superset of partially labeled samples. A subset of semi-supervised learning methods involves learning representations of each sample and based on similarity of representations, propagating labels for the subset of labeled samples to the larger set of samples. These techniques can iteratively learn representations, propagate labels, then update the representations based on the propagated labels. The representations are generated such that pairwise distance of representations for similar (e.g., same ground truth label) samples is small and pairwise distance of representations for different (e.g., different ground truth label) samples is large. Similarity metrics between samples are generated by comparing representations for multiple different transformations of the samples which increases the fidelity of similarity metrics across transformations—this is known as “contrastive learning.”

### BRIEF DESCRIPTION OF THE DRAWINGS

Embodiments of the disclosure may be better understood by referencing the accompanying drawings.

FIG. 1 is a schematic diagram of an example system for training contrastive credibility propagation (CCP) neural networks for generating labels from a set of labeled and unlabeled samples.

FIG. 2 is a schematic diagram of an example architecture for CCP neural networks trained with contrastive learning and credibility vectors

FIG. 3 is a flowchart of example operations for generating labels for partially labeled samples with CCP using credibility vectors and training a classifier neural network with the labels.

FIG. 4 is a flowchart of example operations for generating soft labels for partially labeled samples with a representation neural network.

FIG. 5 is a flowchart of example operations for updating credibility vectors for unlabeled samples of a current batch based on generated representations for the unlabeled samples.

FIG. 6 is a flowchart of example operations for subsampling normalized credibility vectors.

FIG. 7 is a flowchart of example operations for detecting potential data leaks in sensitive documents for DLP using a classifier trained with CCP with credibility vectors

FIG. 8 depicts an example computer system with a CCP neural network trainer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Semi-supervised learning experiences pitfalls due to error propagation when trying to learn labels for a set of unlabeled samples using an initial set of samples with ground truth labels. In the context of a semi-supervised labeling task with contrastive learning, similarity metrics between samples are used for label propagation by assigning same labels to similar samples according to pairwise similarity metrics. The similarity metrics are generated by inputting transformed samples into a neural network and comparing outputs that lie in some representation space, wherein transformed samples are according to randomly chosen ones of a set of transformations. Thus, the similarity metrics vary both across choice of transformations and as the neural network generating the representations is iteratively trained. Errors in the similarity metrics between any two samples can lead to an incorrect label. Incorrect labels can then propagate to other samples in a cycle of negative reinforcement. Moreover, a given sample can have high similarity (in the representation space) to multiple samples with multiple labels, and tiebreaker choices to resolve this ambiguity can additionally propagate incorrect labels. Lastly, because cross-entropy is known to be sensitive to label errors, a classifier trained on a cross-entropy loss function can be error prone.

Credibility-based contrastive learning has been created that introduces credibility vectors in semi-supervised contrastive learning which improves robustness to the aforementioned errors across batches and epochs of training. A trainer for credibility-based contrastive learning assigns each sample a credibility vector with each class label entry having a value in [−1,1]. The values 1, −1, and 0 respectively indicate positive certainty of belonging to a given label, negative certainty of belonging to a given label, and uncertainty of belonging to a given label. Credibility vectors address a typical issue in contrastive learning: ambiguity for class assignment resulting from a given sample being similar to multiple other samples with different labels. The trainer disclosed herein normalizes credibility vectors by their largest entry—thus credibility vectors with multiple large entries get those entries scaled close to 0. This reduces label emphasis and clarifies handling of samples that could belong to multiple labels. Additionally, the trainer averages credibility vectors, and clips entry values to [0,1] across training iterations which reduces error propagation. In addition to averaging credibility vectors across training iterations, updated credibility vectors for different data transformations are averaged within each batch of training data. This reduces the effect of bad similarity metrics for particular batches of training data because each batch uses a randomly sampled pair of transformations of samples and similarity metrics are generated based on representations of the transformed samples. At each iteration, the trainer subsamples credibility vectors with low certainty of assigning labels to samples (i.e., sets these credibility vectors to zero vectors) at a rate that is determined by tracking changes to the distribution of the credibility vectors at various subsampling rates.

The credibility vectors are learned during training of a “representation neural network” that learns representations of samples from which similarity metrics are generated. The loss function for the representation neural network has both the credibility vectors and similarity metrics from the representations it generates as inputs and therefore the credibility vectors and representations are learned in tandem. After training the representation neural network, the trainer clips the credibility vectors to have entries in [0,1] and used as soft labels for samples that indicate likelihoods of membership to each of a set of classes corresponding to labels. Labels are then learned by a “classifier neural network” using the soft labels as training data. Separation of “soft” and “hard” label generation reduces errors in models that learn incorrect “hard” labels and propagate the incorrect labels.

Credibility-based contrastive learning can be used for DLP. In the context of DLP, the trainer can train a classifier neural network on labeled public documents and unlabeled private documents. The trained classifier neural network is robust to reverse engineering of training data including private (potentially sensitive) documents. An entity (e.g., service provider) can run the trained classifier neural network without directly observing any potentially sensitive data. Moreover, the effectiveness of CCP allows for high accuracy generation of pseudo-labels for the task for partially labeled public and private documents prior to training the classifier neural networks, resulting in high quality classifications by the trained classifier neural network.

### Example Illustrations

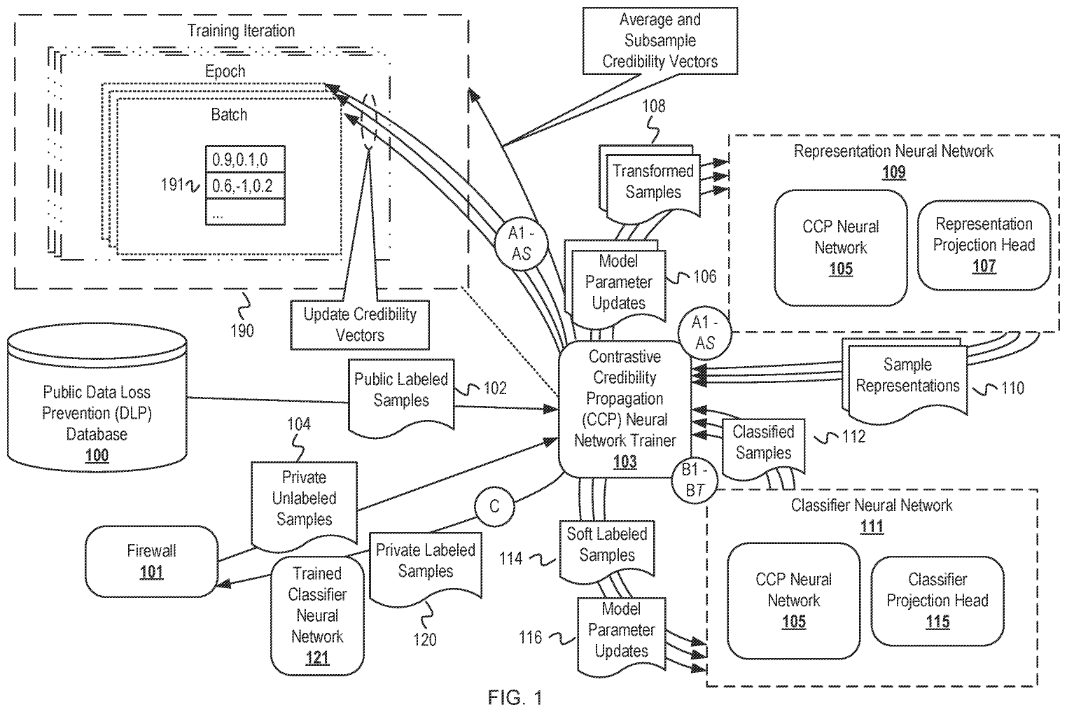

FIG. 1 is a schematic diagram of an example system for training contrastive credibility propagation (CCP) neural networks for generating labels from a set of labeled and unlabeled samples. A CCP neural network trainer (“trainer”) 103 receives from a public DLP database 100 public labeled samples 102 and from a firewall 101 private unlabeled samples 104. The trainer 103 then uses the samples 102, 104 to first train a representation neural network 109 comprising an CCP neural network 105 and a representation projection head 107 and then train a classifier neural network 111 comprising the CCP neural network 105 and a classifier projection head 115. The representation neural network 109 generates representations of samples at each batch iteration during training. These representations have pairwise distances in representation space (i.e., a vector space of the representations) that quantify pairwise similarity between samples for class assignment—labels for samples with ground truth labels are propagated to similar unlabeled samples. The trainer 103 initializes credibility vectors and throughout training updates the credibility vectors. The loss function for the representation neural network 109 computes loss using pairwise similarity from sample representations and the credibility vectors. Thus, the trainer uses sample representations and credibility vectors in tandem to determine labels. The credibility vectors are updated throughout training of the representation neural network 109 as indicated by a conceptual diagram 190 showing the batches within epochs within a training iteration. Once training of the representation neural network 109 is complete, the trainer 103 clips the credibility vectors to have entry values in [0,1] and uses the clipped credibility vectors as soft labels to train the classifier neural network 111. Entries of credibility vectors have values referred to as “certainty values” throughout for indicating the certainty that a sample belongs to a class corresponding to the entry. “Class” is used throughout to refer to a particular classification of a sample and “label” is used throughout to refer to an identifier associated with a class. “Soft label” refers to a credibility vector having certainty values in [0,1]. “Sample” refers to a data object used in a semi-supervised learning task, e.g., the text documents for DLP described variously herein.

The public DLP database 100 comprises a database of DLP samples with known/ground truth labels that are publicly available. These samples comprise text documents. The private unlabeled samples 104 comprise text documents intercepted by the firewall 101 corresponding to sensitive customer data. For instance, the firewall 101 can be running natively on an endpoint device, can be intercepting samples in network traffic between a private network and the Internet, etc. to identify sensitive documents subject to a DLP policy. The trainer 103 receives samples 102, 104 and generates embeddings that convert the text documents to embedding vectors. For instance, the trainer 103 can parse the text documents to extract tokens delimited by special characters such as “ ”, “.”, “,”, “:”, etc. and can generate a vector of tokens. The trainer 103 can then apply a text embedding algorithm to the vectors of tokens such as doc2vec. The type of preprocessing applied to the samples 102, 104 can vary with respect to implementation and can depend on architecture of the neural networks 109, 111. Using a DLP to illustrate, each sample is labeled as according to a sensitivity classification, for example “confidential” or “unrestricted”.

FIG. 1 is annotated with a series of letters A-C. Each stage represents one or more operations. Although these stages are ordered for this example, the stages illustrate one example to aid in understanding this disclosure and should not be used to limit the claims. Subject matter falling within the scope of the claims can vary from what is illustrated.

At stages A1-AS, the trainer 103 proceeds to train the representation neural network 109 across S training iterations. Each training iteration includes multiple epochs and each epoch includes multiple batches. Each iteration executes 3 routines, an outer loop routine that trains the neural network according to the loss function depending on sample representations and credibility vectors for each batch (hereinafter “Algorithm 1”), a first inner routine that updates the credibility vectors within each batch (hereinafter “Algorithm 2”), and a second inner routine that determines a rate at which to subsample credibility vectors for each training iteration (hereinafter “Algorithm 3”). Within each batch, the trainer 103 communicates transformed samples 108 and model parameter updates 106 for the batch to the representation neural network 109. The transformed samples 108 are transformations of embedding vectors of the samples 102, 104. The representation neural network 109 outputs to the trainer 103 sample representations 110 generated by inputting the transformed samples 108 into the representation neural network 109.

The transformations that are applied to samples prior to generating representations comprise an identity function transformation, a differential privacy transformation, a gaussian noise transformation, a vector hide transformation, a paragraph swap transformation, a random vector swap transformation, and a scramble transformation. The identity function transformation returns the embedding vectors for samples without modification. The differential privacy transformation applies Laplacian noise to the embedding vectors with varying strength ∈ between 10 and 100. The Gaussian noise transformation applies Gaussian noise to the embedding vectors with μ (mean) and σ (standard deviation) varying between [−0.5, 0.5] and [0.01, 0.05], respectively. The vector hide transformation randomly replaces embedding vectors with a learned padding vector used to pad short inputs, with the percentage of embedding vectors varying from 10% to 25%. The learned padding vector comprises an embedding vector in the vocabulary of a natural language processor that is learned alongside the rest of the embedding vectors in the vocabulary and represents a null string of characters that is used to pad shorter samples to have a uniform size. The paragraph swap transformation chooses a random index in the embedding vectors and swaps entries above and below that index. The random vector swap transformation randomly replaces values at randomly chosen indices in embedding vectors with a random value from the whole vocabulary (according to the natural language processing algorithm used to generate the embedding vectors) at a frequency randomly chosen between 10% and 25%. The scramble transformation Randomly selects indices of embedding vectors and randomly scrambles their order (e.g., by choosing a permutation uniformly at random), wherein the frequency of selected indices is chosen at random between 10% and 25%.

The general approach for generating the credibility vectors that are then used to train the classifier neural network 111 is to train the representation neural network 109 to learn representations of samples in an embedding space for sample representations that aligns with labels in the public labeled samples 102. At each iteration through a batch during training, credibility vectors are updated according to representations for corresponding samples, and then the representation neural network 109 is updated based on a loss function that has both the credibility vectors and the representations as inputs. Referring to FIG. 1, each batch has credibility vectors 191 for the samples of a batch. The trainer updates the credibility vectors 191 in a batch iteration. After completing the epochs of a training iteration, the trainer 103 averages the credibility vectors 191 and those of other batches across the epochs and sets as zero vectors a subsample of the credibility vectors. This ensures that the model is learning to align the sample representations 110 with corresponding credibility vectors. Intuitively, this means the representation neural network 109 is learning representations where, for a sample with a representation close to a labeled sample representation, the credibility vector is positively certain (close to 1) for the entry of the corresponding class for the labeled sample and negatively certain (close to −1) or uncertain (close to 0) for every other entry. Conceptually, the representation space can be thought of as Euclidean space for simplicity, although any representation space with an inner product and a norm can be used.

The trainer 103 implements Algorithms 1-3 to train the representation neural network 109, which rely on notation used in the below pseudocode. For a set of N partially labeled samples X={x₀, . . . , x_{N-1}}, each sample belongs to a class in a set of classes c, where |c|=n_{c}. The indices of the set of labeled samples in X is L⊂{0,1, . . . , N−1} and the indices of the set of unlabeled samples is U⊂{0,1, . . . , N−1}. Each sample is associated with a credibility vector {q₀, . . . , q_{N-1}}, qᵢ∈{−1,1}ⁿ^{_{c}}. For each k ∈ c, the entry for class k in credibility vector qᵢ is denoted q_{i,k}∈{−1,1}. There is a set of text data transformations T from which two (t₁, t₂) are subsampled at each batch. These transformations are used for contrastive learning—two representations for each sample according to each of the transformations is generated for a batch. The indices of samples selected at each batch are denoted B⊂L∪U, with Bᵤ denoting indices of unlabeled samples and Bₗ denoting indices of labeled samples. The CCP neural network 105 is represented as a function ƒ_{b} and the representation projection head 107 is represented as a function ƒ_{z}, wherein outputs of ƒ_{z} are denoted with the variable z having a subscript corresponding to an index of a corresponding sample and a superscript indicating a transformation applied to the sample prior to inputting to the representation neural network 109. pₗₐₛₜ and dₘ are parameters used in determining a subsampling rate at each iteration of Algorithm 1 and are clarified in Algorithm 3 below. Using this notation, the following is pseudocode for Algorithm 1:

Algorithm 1

1: Given n_{epochs}, T, {qₗ}_{l∈L}, pₗₐₛₜ, dₘ
2: if {qᵤ}_{{ueU}} are not initialized then
3: Initialize qᵤ = [0,0, ... ,0] for u ∈ U
4: end if
5: Initialize neural networks f_{b}, f_{z}
6: for δ ∈ {1,2, ... , n_{epochs}} do
7: for partially-labeled batches {(xᵢ, qᵢ)}_{i∈B}
8: Randomly draw t₁, t₂ ∈ T to form { (xᵢ^{t}^{₁}, qᵢ), (xᵢ^{t}^{₂}, qᵢ)}_{i∈B}
9: Compute zᵢ^{t}^{₁} = f_{z} (f_{b}(xᵢ^{t}^{₁}) ), zᵢ^{t}^{₂} = f_{z} (f_{b}(xᵢ^{t}^{₂}) ) for i ∈ B
10: Compute { \tilde{q}ⱼ^{δ}}_{j∈B}_{ᵤ} using Algorithm 2
11: Train f_{b}, f_{z} using gradient descent with loss function L_{SSC}
computed with {(zᵢ^{t}^{₁}, qᵢ), (zᵢ^{t}^{₂}, qᵢ)}_{i∈B}
12: end for
13: end for
$14 : Update {\hat{q}}_{u} = 2 {\sum }_{δ = 1}^{{n}_{epochs}} \frac{{\tilde{q}}_{j}^{δ}}{{n}_{epochs}}$
15: for k ∈ c do
$16 : {q}_{u , k} = {\hat{q}}_{u , k} - {max}_{{k}^{′} ∈ c \backslash k} {\hat{q}}_{u , {k}^{′}} for u ∈ U$
17: end for
18: Clip all values in {qᵤ}_{u∈U} to lie in [0,1]
19: Compute p, {wu}_{u∈U} via Algorithm 3
20: Set the bottom p % of {qᵤ}_{u∈U} to zero vectors ordered by {wᵤ}_{u∈U}
21: pₗₐₛₜ = p
22: dₘ = dₘ/10
23: Return f_{b}, pₗₐₛₜ, dₘ, {qᵤ}_{u∈U}

At lines 2-4, Algorithm 1 sets the credibility vectors for unlabeled samples to zero vectors. Zero credibility vectors mean that no information about classes with which to label the unlabeled samples is known. At lines 5-13, the representation neural network 109 is trained in various epochs and batches within each epoch using a loss function L_{SSC} (defined below) based on credibility vectors and representations output by the representation neural network 109 on samples in the batch. Each batch can be sampled from the labeled and unlabeled samples uniformly at random.

At line 14, the credibility vectors are averaged across epochs. This increases robustness to errors that occur within each batch for each epoch. Note that the initial credibility vectors {qᵤ}_{u∈U} are used across all batches and epochs in Algorithm 1 as inputs to the representation neural network 109 for training as opposed to iteratively updating the credibility vectors using the operations at line 10. This avoids issues such as confirmation bias where the representation neural network 109 will learn incorrect labels corresponding to incorrect credibility vectors and use those credibility vectors as inputs to the loss function at future batches, propagating the incorrect labels in a negative reinforcement cycle. Additionally, errors can be averaged out by the operation at line 14 so that they do not propagate to future epochs/batches.

At lines 15-17, each entry of each credibility vector is normalized by subtracting the maximal entry among all other entries of the credibility vector. This has the effect of pronouncing one entry for a credibility vector with positive certainty in one class and negative certainty or uncertainty in other classes and, for a credibility vector with positive certainty for multiple classes, normalizing corresponding entries towards zero. To illustrate with simple examples, consider first a credibility vector [1,−1,−1] with 100% certainty of belonging to a first class and a 100% certainty of not belonging to a second and third class (note that this is a credibility vector for a labeled sample). Then the equation at line 16 gives the vector [2, −2, −2] which pronounces the most certain class. Conversely, for a credibility vector [0.9, 0.9,0] having a 90% certainty of belonging to a first and second class and unknown certainty of belonging to a third class, the equation at line 16 gives the vector [0,0,−0.9] which zeroes out the two positive certainty classes. Line 16 enforces that entries in credibility vectors for classes with equal positive certainty get zeroed out (when they are the maximal certainty classes).

Finally, the lines 17-22 relate to subsampling credibility vectors. Once the subsampling percentage is determined, the bottom subset of credibility vectors is set to [0,0, . . . ,0] according to this percentage. The ordering of credibility vectors when subsampling is determined according to {wᵤ}_{u∈U} which are weights indicating degree of certainty for corresponding credibility vectors (the equation for these weights is given explicitly in Algorithm 3). Note that zeroing out credibility vectors with low certainty also prevents error propagation—if a credibility vector does not give a strong signal for a particular class, then it is likely error prone and zeroing out prevents any errors from propagating to future training iterations.

Algorithm 1 can execute multiple times using credibility vectors output by a previous iteration as input. The iterations can continue until a termination criterion is satisfied. The termination criterion can depend on the various parameters in Algorithm 1, for instance that a threshold number of iterations have occurred, that a training termination criterion for the representation neural network 109 is satisfied, that the credibility vectors are stabilizing across iterations, or any combination of the foregoing.

To define the loss function L_{SSC} for the representation neural network 109, additional notation is used. Note that the loss function L_{SS} is computed for zᵢ^{t}^{₁} and zᵢ^{t}^{₂}. For notational convenience we use zᵢ to refer to either transformation depending on which loss function value is being computed. Entries of a |B|×|B| pairwise matching matrix M are defined as m_{i,j}=qᵢ·qⱼ for ij∈B. Pairwise similarities are scaled by a temperature parameter τ to form a |B|×|B| matrix A defined by entries

$${a}_{i , j} = exp ( \frac{ϕ ( {z}_{i} , {z}_{j} )}{τ} )$$

for i,j∈B. Entries of a strength matrix Ω are defined as ω_{i,j}=max(qⱼ) for i,j∈B—note that Ω has identical rows and each ω_{i,j} contains the confidence of qⱼ. The pairwise similarities a_{i,j} are normalized by this confidence. Comparisons of the same sample to itself are avoided with the modifications M=M⊙(1−I), A=A⊙(1−I) (1 is a matrix of all ones, I is the identity matrix, and ⊙ is elementwise multiplication). The loss function L_{SSC} is the following:

$${L}_{SSC} = - \frac{1}{\vert B \vert} {\sum }_{i ∈ B} \frac{1}{{\sum }_{j ∈ B} {m}_{i , j}} {\sum }_{j ∈ B} {m}_{i , j} log ( {a}_{i , j} / {\sum }_{j} {a}_{( i , j )} {ω}_{i , j} )$$

This loss is a weighted arithmetic mean of the pairwise matches m_{i,j} weighted by a term Σ_{j∈B}m_{i,j}log(a_{i,j}/Σⱼa_{(i,j)}ω_{i,j}) that incorporates similarity of between representations zᵢ (thus, the loss incorporates information both about credibility vectors and representations of samples). This loss function is then applied via backpropagation using gradient descent on the neural network f_{z}(f_{b}(·)).

Before presenting Algorithm 2 which generates updated credibility vectors at each batch based on similarities between representations for corresponding samples, we define the distance between representations output by the representation neural network 109 as

$$ϕ ( {z}_{i} , {z}_{j} ) = 1 - arc cos \frac{{z}_{i} \cdot {z}_{j}}{‖ {z}_{i} ‖ ‖ {z}_{j} ‖}$$

In the above equation, zᵢ·zⱼ is the inner product between zᵢ and zⱼ in the representation space (e.g., the dot product in Euclidean space) and ||zᵢ|| is the norm of zᵢ in the representation space (e.g., the Euclidean norm in Euclidean space). This is the angular distance between zᵢ and zⱼ. Other distances, such as cosine similarity can be used. Angular distance captures close distances and far distances more granularly than other distances which is conducive to determining high quality similarity metrics. Pseudocode for Algorithm 2 is the following:

Algorithm 2

1: Given {(zᵢ^{t}^{₁}, qᵢ), (zᵢ^{t}^{₂}, qᵢ)}_{i∈B}
2: Compute q̅_{i,k} = max(0, q_{i,k} ) for i ∈ B, k ∈ c
3: for j ∈ B_u do
4: for t ∈ {t₁, t₂} do
5: for k ∈ c do
$6 : {ψ}_{j , k}^{t} = \frac{{\sum }_{i ∈ B \backslash j} ϕ ( {z}_{j}^{t} , {z}_{i}^{{t}_{1}} ) {\overline{q}}_{i , k} + ϕ ( {z}_{j}^{t} , {z}_{i}^{{t}_{2}} ) {\overline{q}}_{i , k}}{2 {\sum }_{i ∈ B \backslash j} {\overline{q}}_{i , k}}$
7: end for
8: for k ∈ c do
$9 : {\tilde{q}}_{j , k}^{t} = {ψ}_{j , k} - {max}_{{k}^{′} ∈ c \backslash k} {ψ}_{j , {k}^{′}}$
10: end for
11: end for
$12 : Store {\tilde{q}}_{j} = \frac{{\tilde{q}}_{j}^{{t}_{1}} + {\tilde{q}}_{j}^{{t}_{2}}}{2}$
13: end for
14: Return {qⱼ}_{j∈B}_{ᵤ}

The purpose of Algorithm 2 is to use the most recent representations of each sample to align credibility vectors of similar samples in representation space (according to the ϕ metric). At line 2, negative certainties are set to zero for each entry of each credibility vector—this means that negative certainties have no effect in subsequent operations. Then, at line 6, an updated value for each entry is generated for one of the transformations t₁, t₂ (the values for each transformation are averaged at line 12). This updated value is, for a given class, a normalized average of distances to other samples in the representation space according to the metric ϕ weighted by certainty values that those other samples belong to the given class. This has an attractive force towards credibility vectors of similar samples in the representation space. The updated value accounts for distance between representations for both transformations t₁, t₂ which reduces potential error in one of these representations (this is a contrastive learning aspect of Algorithms 1-3). Subsequently, at line 9 the credibility vectors are shifted in the same manner as in line 16 of Algorithm 1 to reduce the effect of having large certainty values in multiple entries of credibility vectors.

Algorithm 3 determines what percentage of credibility vectors to subsample (set to zero vectors) at each iteration of Algorithm 1. Pseudocode for Algorithm 3 is the following:

Algorithm 3

1: Given {\hat{q}ᵤ}_{u∈U}, {qu}_{u∈U}, pₗₐₛₜ, dₘ
2: Compute {wᵤ = max \hat{q}ᵤ}_{u∈U}
$3 : Q = \frac{{\sum }_{u} {q}_{u}}{{\sum }_{u , k} {q}_{u , k}}$
4: for pᵢ ∈ {0%, 1%, ... , pₗₐₛₜ − 1%} do
5: Set the bottom p % set to (0,0, ... ,0) ordered by {wᵤ}_{u∈U}
$6 : P = \frac{{\sum }_{u} {q}_{u}}{{\sum }_{u , k} {q}_{u , k}}$
$7 : {d}_{i} = {D}_{KL} ( P ∥ Q ) = {\sum }_{k ∈ c} {P}_{k} {log}_{2} ( \frac{{P}_{k}}{{Q}_{K}} )$
8: end for
9: p = max {pᵢ for all i such that dᵢ < dₘ}
10: Return p, {wᵤ}_{u∈U}

Line 2 of Algorithm 3 computes weights for each credibility vector. Note that these weights are applied to credibility vectors after averaging at line 14 of Algorithm 1 but prior to clipping at line 18. This is because the clipping operation scales down magnitudes of very certain (i.e., highly positive) entries of the credibility vectors, which loses information that could otherwise be used for ordering by certainty.

Line 3 of Algorithm 3 generates a probability distribution Q from the clipped credibility vectors. This divides each entry of the clipped credibility vectors by the sum of the entries so that they sum to 1.

Lines 4-8 iterate through candidate subsampling percentages below a threshold percentage (pₗₐₛₜ). At each iteration, the candidate vectors are ordered according to the weights computed at line 2 and the bottom pᵢ % of the credibility vectors are set to zero vectors. Then, another probability distribution P is generated in the same manner as Q for the credibility vectors with the bottom pᵢ % set to zero vectors. Then, at line 7, the Kullback-Leibler (KL) divergence from P to Q is computed. The KL divergence is a statistical distance from P to Q—it quantifies how much setting the bottom pᵢ % of the credibility vectors to zero vectors affects the overall distribution of the credibility vectors. This is more accurate than just subsampling a fixed percentage at each iteration of Algorithm 1.

At line 9, a subsampling percentage p is determined as the maximal candidate percentage with corresponding KL divergence between a threshold KL divergence dₘ (note that the KL divergence increases with increasing subsampling percentages). dₘ varies across iterations of Algorithm 1 (and thus iterations of Algorithm 3 which occurs once during Algorithm 1) because it is scaled down by a factor of 10 at line 22 of Algorithm 1. Moreover, the maximal candidate subsampling percentage is decreasing across training iterations because it is set to the previous subsampling percentage at line 21 in Algorithm 1. Initialization of dₘ and Pₗₐₛₜ at a first iteration of Algorithms 1, 3 can be tuned based on experimental results. For instance, for the first iteration the values Pₗₐₛₜ=90% and dₘ=0.01 can be used.

At stages B1-BT, the trainer 103 trains the classifier neural network 111 using soft labeled samples 114. The iterations of Stage B continue until a performance criterion is satisfied. The soft labeled samples 114 comprise transformed samples 108 along with credibility vectors generated at stage A. Training occurs using backpropagation by feeding the soft labeled samples 114 into the classifier neural network 111, receiving classified samples 112 as outputs of the classifier neural network 111, and determining model parameter updates 116 based on a loss function between classifications in the classified samples 112 and soft labels in the soft labeled samples 114. The classifications in the classified samples 112 comprise vectors of likelihood values for each sample. A vector of likelihood values for a sample indicates likelihood of belonging to each of the set of classes. Note that the CCP neural network 105 is also used in the representation neural network 109. The CCP neural network 105 is re-initialized prior to training the classifier neural network 111. The classifier projection head 115 is represented as a function ƒ_{g} such that the classifier neural network 111 is the function ƒ_{g}(ƒ_{b}(·)) . Outputs of the classifier neural network 111 in a batch are represented as gᵢ, i∈B. The loss function for the classifier neural network 111 is cross entropy loss which can be computed as

$${L}_{CE} = - \frac{1}{\vert B \vert} {\sum }_{i ∈ B} {\sum }_{k ∈ c} {q}_{i , k} log ( {σ ( {g}_{i} )}_{k} )$$

In this equation, σ is a softmax function and the k subscript denotes the kth entry of the vector output by the softmax function for the ith sample in the batch.

At stage C, once the classifier neural network 111 is trained to generate a trained classifier neural network 121 (e.g., using backpropagation according to the loss function L_{CE} above), the trainer 103 determines hard labels for the private unlabeled samples 104 based on soft labels in the soft labeled samples 114 (i.e., according to credibility vectors generated during training of the representation neural network 109). The trainer 103 can, for instance, assign hard labels for classes of entries having maximal certainty values in each of the corresponding credibility vectors. The trainer 103 can additionally assign null or blank labels to samples in the private unlabeled samples 104 having credibility vectors with maximal entry values that are below a threshold certainty value. The trainer 103 then communicates private samples in the private unlabeled samples 104 paired with corresponding hard labels as private labeled samples 120 and the trained classifier neural network 121 to the firewall 101. The firewall 101 then performs corrective action based on sensitive samples in the private labeled samples 120. For instance, the firewall 101 can analyze corresponding threat levels for each of the sensitive samples and, based on the threat levels exceeding a threshold, block or limit communications along corresponding channels where the samples were intercepted.

The firewall 101 additionally deploys the trained classifier neural network 121 for classification of potentially sensitive documents for DLP. In some embodiments, the firewall 101 can communicate the trained classifier neural network 121 to a 3^{rd} party (not depicted) for native implementation to avoid communication of private samples to the firewall 101 over the Internet. Moreover, during training the private unlabeled samples 104 and public labeled samples 102 can be obfuscated or encrypted so that the trainer 103, the representation neural network 109, and the classifier neural network 111 do not observe sensitive documents during training. The 3^{rd} party can then deploy the trained classifier neural network 121 to classify obfuscated or encrypted documents.

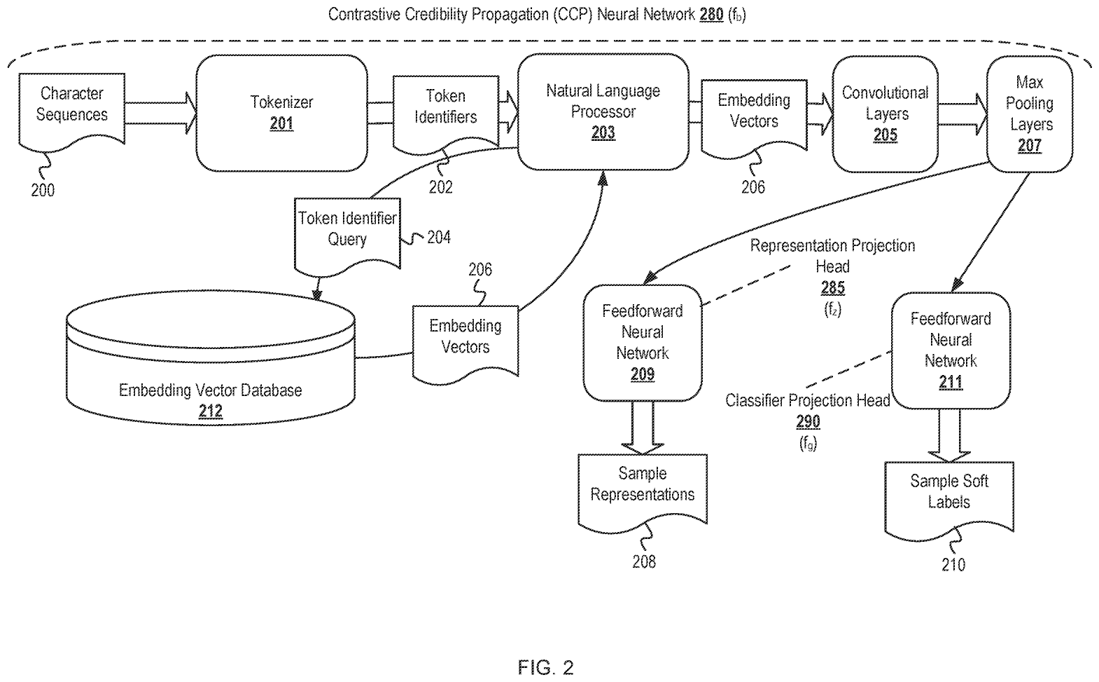

FIG. 2 is a schematic diagram of an example architecture for CCP neural networks trained with contrastive learning and credibility vectors. An CCP neural network 280 (corresponding to ƒ_{b} in the description of Algorithms 1-3) comprises a tokenizer 201, a natural language processor 203, convolutional layers 205, and max pooling layers 207. The tokenizer 201 receives character sequences 200 corresponding to samples for DLP (i.e., text documents) and extracts token identifiers 202 that are communicated to the natural language processor 203. For instance, the tokenizer 201 can use the sub-word segmentation functionality of Byte-Pair Encoding (BPE)mb to generate the token identifiers 202. The natural language processor 203 receives the token identifiers 202 and queries an embedding vector database 212 with a token identifier query 204 indicating the token identifiers 202. The embedding vector database 212 returns embedding vectors 206 corresponding to the token identifiers 202. The embedding vectors 206 comprise numerical vectors ordered according to the order of the token identifiers 202, i.e., according to the order of the corresponding tokens as they appear in the character sequences 200. The natural language processor 203 can use the sub-word embedding functionality of BPEmb. Any natural language processing implementation that tokenizes the character sequences 200 and then generates embedding vectors can be used (e.g., word2vec).

The embedding vectors 206 are processed through convolutional layers 205. Max pooling layers 207 receive and process outputs of the convolutional layers 205. To exemplify, the convolutional layers 205 can be two stacked copies of a convolutional layer with 32 filters each of size 5×100 that each feed into one of two stacked copies of a convolutional layer with 16 filters of size 3×1. The max pooling layers 207 can comprise a global pooling over activation maps of each of the preceding filters. The type, order, and size of the layers of the CCP neural network can vary.

A feedforward neural network 209 receives outputs of the max pooling layers 207. The feedforward neural network 209 comprises a representation projection head 285 indicated as ƒ_{z} in the description of Algorithms 1-3. The feedforward neural network 209 outputs sample representations 208 of DLP samples corresponding to the character sequences 200. A feedforward neural network 211 also receives outputs of the max pooling layers 207 and outputs sample soft labels 210 for DLP samples corresponding to the character sequences 200. To exemplify, feedforward neural networks 209 and 211 can be 2-layer feedforward neural networks. Feedforward neural network 209 can have a hidden and output layer of size 64 and feedforward neural network 211 can have a hidden layer of size 64 and an output layer of size equal to a number of classes for DLP samples. The feedforward neural network 211 comprises a classifier projection head 290 indicated as ƒ_{g} in Algorithms 1-3. The CCP neural network 280 and the representation projection head 285 combine to form a representation neural network and the CCP neural network 280 and the classifier projection head 290 combine to form a classifier neural network.

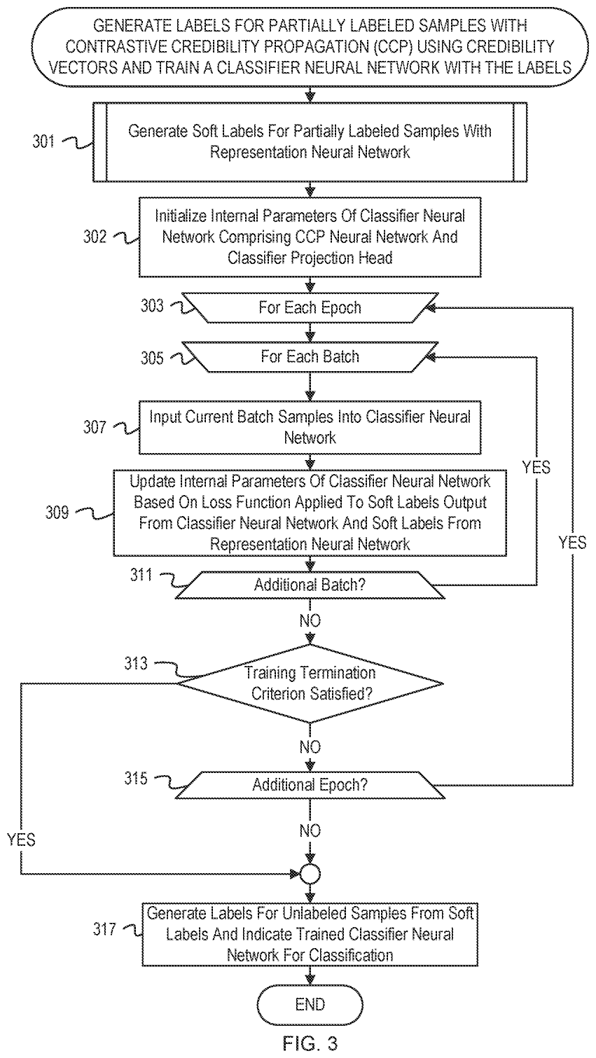

FIGS. 3-7 are flowcharts of example operations for generating labels for partially labeled samples with CCP via credibility vectors and detecting potentially sensitive documents for DLP. The example operations are described with reference to a trainer and a firewall for consistency with the earlier Figure(s) and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

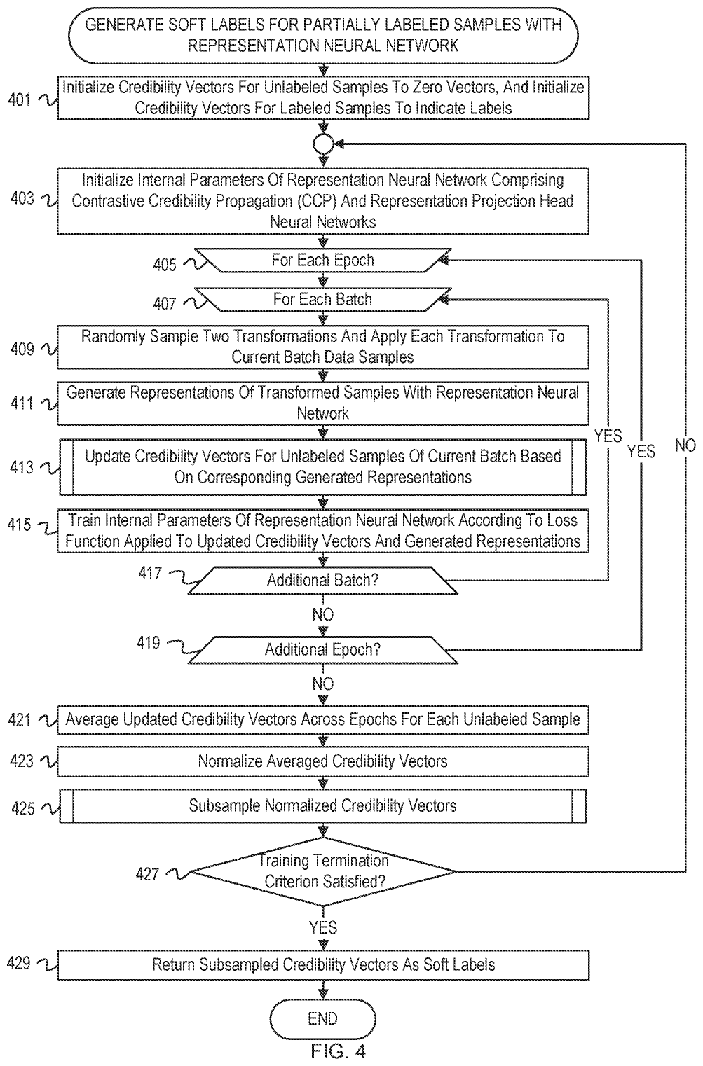

FIG. 3 is a flowchart of example operations for generating labels for partially labeled samples with CCP using credibility vectors and training a classifier neural network with the labels. At block 301, a trainer generates soft labels for partially labeled samples with a representation neural network. The representation neural network comprises a CCP neural network that feeds into a representation projection head that outputs representations of the samples. The soft labels comprise credibility vectors for each unlabeled sample belonging to each of a set of classes and the credibility vectors are updated in tandem with representations output by the representation neural network during training. The operations at block 301 are described in greater detail in reference to FIG. 4.

At block 302, the trainer initializes internal parameters for a classifier neural network comprising a CCP neural network and a classifier projection head. The CCP neural network comprises a neural network that was previously used in the representation neural network to generate soft labels (the credibility vectors of unlabeled samples). Resetting and initializing the internal parameters of the CCP neural network prior to classification is a design choice and, in some implementations, the CCP neural network can maintain its previous state during training of the representation neural network. The CCP neural network comprises a natural langue processing layer that preprocesses samples to generate embedding vectors, convolutional layers, and max pooling layers. The classifier projection head comprises a feedforward neural network of one or more dense feedforward layers and an activation layer to output soft labels.

At block 303, the trainer iterates through epochs of training. The number of epochs can be a maximal number of epochs based on desired training time and available computing resources.

At block 305, the trainer subsamples a batch of partially labeled samples as part of training the classifier neural network at the current epoch. Batches can be subsampled uniformly at random from the set of partially labeled samples. Each batch comprises a distinct set of samples to other batches, and the batches cover the whole set of partially labeled samples.

At block 307, the trainer inputs the current batch samples into the classifier neural network. The trainer feeds the current batch samples into the CCP neural network and outputs of the CCP neural network are input to the classifier projection head which outputs soft labels.

At block 309, the trainer updates internal parameters of the classifier neural network based on a loss function applied to outputs of the classifier neural network. The loss function can be, for instance, L_{CE} defined above. This loss function is applied to the difference between the outputs of the classifier neural network and the soft labels corresponding to credibility vectors generated during training of the representation neural network. Backpropagation is used to update the internal parameters by propagating loss via gradient descent through the layers of the classifier neural network.

At block 311, the trainer continues subsampling batches of the partially labeled samples. If there is an additional batch, operational flow returns to block 305. Otherwise, operational flow proceeds to block 313.

At block 313, the trainer determines whether a training termination criterion is satisfied. The training termination criterion can be that the loss function averaged across batches is sufficiently low, that loss for a test set of samples separate from those used for training is sufficiently low, that internal parameters of the classifier neural network converge across batch iterations, etc. If the training criterion is satisfied, operational flow skips to block 317. Otherwise, operational flow proceeds to block 315.

At block 315, the trainer determines whether there is an additional epoch for training the classifier neural network. If there is an additional epoch, operational flow returns to block 303. Otherwise, operational flow proceeds to block 317.

At block 317, the trainer generates labels for unlabeled samples from soft labels and indicates the trained classifier neural network for classification. The trainer assigns each unlabeled sample a label according to a class for the maximal entry value of the corresponding certainty vector. Additionally, the trainer indicates the classifier neural network trained in the foregoing as a trained classifier for additional/unseen unlabeled samples.

FIG. 4 is a flowchart of example operations for generating soft labels for partially labeled samples with a representation neural network. At block 401, a trainer initializes credibility vectors for unlabeled samples of the partially labeled samples to zero vectors and initializes credibility vectors for labeled samples of the partially labeled samples to indicate the corresponding labels. The credibility vectors for the labeled samples have 0 entries for classes not corresponding to the label and a 1 entry for the class corresponding to the label. For instance, for a sample labeled with a third class in a set of three classes, the initial credibility vector is [0,0,1].

At block 403, the trainer initializes internal parameters of a representation neural network comprising a CCP neural network and a representation projection head neural network. The CCP neural network comprises natural language processing layers, convolutional layers, and max pooling layers, or any other layers depending on underlying distribution of the partially labeled samples, the number of partially labeled samples, architectural considerations, etc. The representation projection head neural network comprises a feedforward neural network of fully connected feedforward layers and outputs to a space that corresponds to representations of the partially labeled samples. Similarity of samples is thus assessed by applying one of a set of transformations to the samples, inputting the samples into the representation neural network, and then computing distance between outputs of the representation neural network. The trainer additionally generates embedding vectors for each of the partially labeled data samples. The embedding vectors can be generated by inputting the partially labeled data samples into natural language processing layers of the CCP neural network.

At block 405, the trainer iterates through epochs of training. The number of epochs can be a maximal number of epochs based on desired training time and available resources.

At block 407, the trainer subsamples a batch of partially labeled samples as part of training the classifier neural network at the current epoch. Batches can be subsampled uniformly at random from the set of partially labeled samples. Each batch comprises a distinct set of samples from other batches, and the batches cover the whole set of partially labeled samples.

At block 409, the trainer randomly samples two transformations from a set of transformations and applies each transformation to the current batch samples. When the samples are text documents being evaluated in the context of data loss prevention, the transformations can comprise an identity function transformation, a differential privacy transformation, a Gaussian noise transformation, a vector hiding transformation, a paragraph swapping transformation, a random vector swapping transformation, and a scrambling transformation. Each of these transformations is applied to embedding vectors of the text documents generated with NLP (e.g., doc2vec).

At block 411, the trainer generates representations of transformed samples with the representation neural network. The trainer inputs two versions of each sample in the current batch samples—one for each randomly sampled transformation—and inputs each transformed sample into the representation neural network to generate the representations as output.

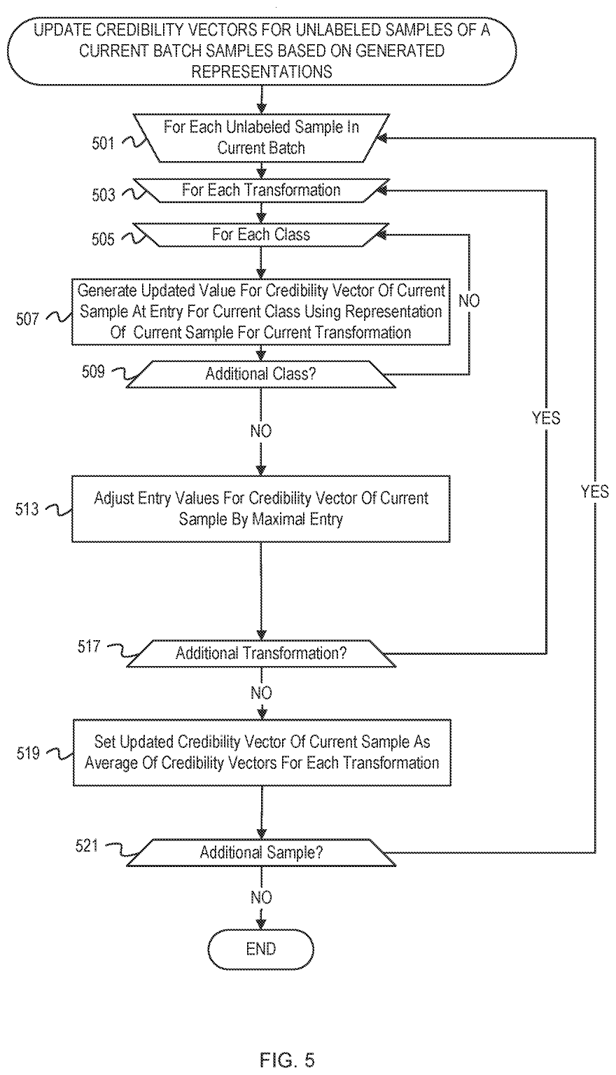

At block 413, the trainer updates credibility vectors for unlabeled samples of the current batch based on the corresponding generated representations. Operations at block 413 are described in greater detail in reference to FIG. 5.

At block 415, the trainer trains internal parameters of the representation neural network according to a loss function applied to the updated credibility vectors and the generated representations. The loss function can be L_{SSC} defined above. The trainer uses backpropagation via gradient descent applied to the loss function to propagate loss through the internal layers of the representation neural network.

At block 417, the trainer continues subsampling batches of the partially labeled samples. If there is an additional batch, operational flow returns to block 407. Otherwise, operational flow proceeds to block 419.

At block 419, the trainer determines whether there is an additional epoch for training the representation neural network. If there is an additional epoch, operational flow returns to block 405. Otherwise, operational flow proceeds to block 421.

At block 421, the trainer averages the updated credibility vectors across epochs for each unlabeled sample. Note that a separate set of credibility vectors are generated at each epoch that update the credibility vectors output by a previous training iteration (i.e., a previous iteration of Algorithm 1). For the first iteration, the updated credibility vectors are generated from the initialized credibility vectors at each epoch. Averaging credibility vectors of unlabeled samples across iterations has the effect of reducing error propagation that occurs when credibility vectors are continuously updated at each batch. Additionally, because transformations are randomly sampled for each batch, this reduces error when a particular transformation results in error-prone representations of samples.

At block 423, the trainer normalizes the averaged credibility vectors. The trainer adjusts entry values in each of the averaged credibility vectors by their maximal entry values and clips entries of the adjusted credibility vectors to lie in [0,1]. Note that this allows computation of a probability distribution representing certainty of each class because the entries are now positive. Additionally, this has the effect of removing negative certainties of samples for classes and instead treats the class as uncertain (0). Additional or less normalization operations can be applied. For instance, averaged credibility vectors need not be clipped or have entry values adjusted. Averaged credibility vectors can be normalized to have a fixed standard distribution or mean.

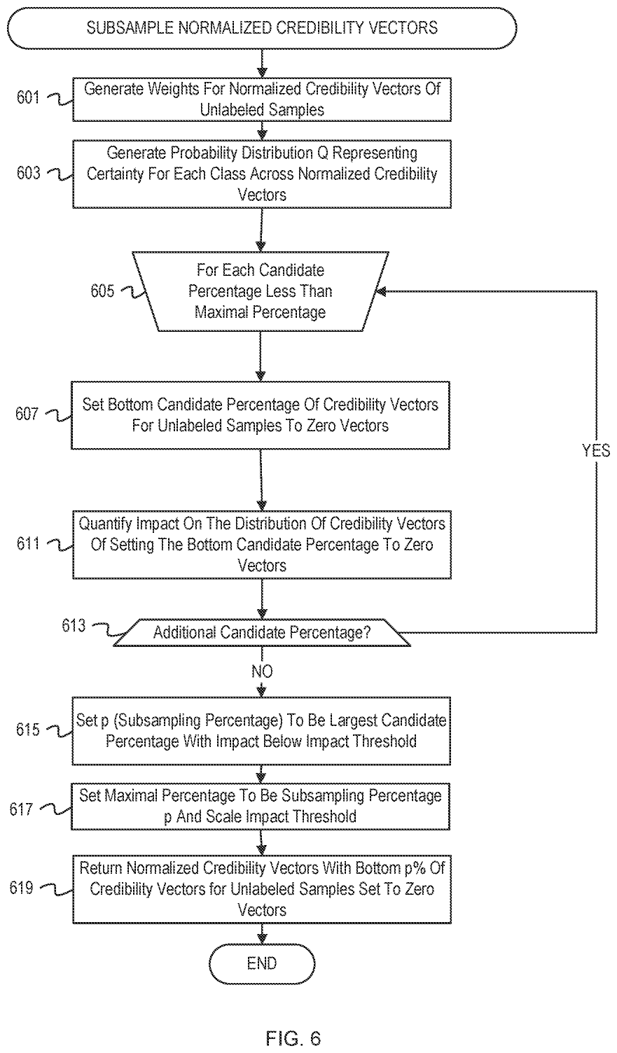

At block 425, the trainer subsamples the normalized credibility vectors. The operations at block 425 are depicted in greater details with reference to FIG. 6.

At block 427, the trainer determines whether a training criterion is satisfied. The criterion can be a fixed number of training iterations for generating soft labels, can be based on the credibility vectors stabilizing across iterations, can be based on a percentage of credibility vectors that were subsampled, can be based on training criteria for the representation neural network, etc. If the trainer determines that the training criterion is satisfied, operational flow proceeds to block 429. Otherwise, operational flow returns to block 403.

At block 429, the trainer returns the subsampled credibility vectors as soft labels for the partially labeled samples. The soft labels are then used to train a classifier neural network to generate labels for unlabeled samples, as described in the foregoing.

FIG. 5 is a flowchart of example operations for updating credibility vectors for unlabeled samples of a current batch based on generated representations for the unlabeled samples. At block 501, the trainer determines an unlabeled sample in the current batch for credibility vector updating as part of iterating through each of the unlabeled samples in the batch.

At block 503, the trainer iterates through both transformations applied to the current batch of samples. Note that each sample in the batch of samples corresponds to two representations—one for each of the randomly chosen transformations at the current batch. While depicted for two representations corresponding to two transformations, any positive number of transformations can be chosen depending on available computing resources. Additional transformations will increase the number of iterations at block 503 and subsequent loops in the flow of FIG. 5.

At block 505, the trainer chooses a class of a set of classes corresponding to labels for the samples as part of iterating through the set of classes relevant to the samples.

At block 507, the trainer generates an updated value at an entry for the current class in the credibility vector of the current sample using the representation of the current sample for the current transformation based on distances from other samples in the embedding space. For instance, the trainer can use the equation at line 5 of Algorithm 2 to determine the updated value. The updated value adjusts the certainty value based on distances to other samples in the representation space weighted by corresponding certainty values using representations of other samples according to both transformations.

At block 509, the trainer determines whether there is an additional class in the set of classes. If there is an additional class, operational flow returns to block 505. Otherwise, operations flow proceeds to block 511.

At block 513, the trainer adjusts the entry values for the credibility vector of the current sample by the maximal entry. For instance, the trainer can use the equation at line 8 in Algorithm 2 to determine the updated certainty value for each entry. The maximal entry is subtracted from non-maximal entries, and the largest non-maximal entry is subtracted from the maximal entry (when every entry is maximal the credibility vector is set to zeroes). This has the effect of scaling down credibility vectors with multiple high credibility values, which would promote uncertainty for those corresponding classes. This reduces error propagation from choosing one of the high certainty values as a label or soft label and dropping the others.

At block 517, the trainer determines whether there is an additional transformation for the current sample. If there is an additional transformation, operational flow returns to block 503. Otherwise, operational flow proceeds to block 519.

At block 519, the trainer sets the updated credibility vector of the current sample as the average of the credibility vectors for each transformation. This reduces potential error due to one of the transformations having error-prone pairwise distances in the representation space, resulting in similarity of ground truth dissimilar samples with distinct classes.

At block 521, the trainer determines whether there is an additional unlabeled sample in the current batch. If there is an additional unlabeled sample, operational flow returns to block 501.

FIG. 6 is a flowchart of example operations for subsampling normalized credibility vectors. Note that the normalized credibility vectors have been clipped so that their entries are in [0,1]. At block 601, the trainer generates weights for normalized credibility vectors of unlabeled samples based on averaged credibility vectors (prior to clipping to [0,1]). The trainer can, for instance, generate the weights according to the equation at line 2 in Algorithm 3 which sets the weights equal to the maximal entry of each averaged credibility vector. Note that the weights correspond to the averaged credibility vectors because the operation of clipping to [0,1] loses ordering information for the credibility vectors. Other choices of weights, such as a difference between the maximal and minimal entries, can be used.

At block 603, the trainer generates a probability distribution Q representing certainty for each class across normalized credibility vectors. The trainer can generate Q according to the equation at line 3 of Algorithm 3 which, for each class, averages corresponding values across normalized credibility vectors and then normalizes the vector values for each of the classes so that it sums to 1 (i.e., is a probability distribution).

At block 605, the trainer selects a candidate percentage less than a maximal percentage as part of iterating through candidate percentages. The trainer starts with candidate percentage 0% and increases the candidate percentage by 1% at each subsequent iteration until the maximal percentage is reached. Other sets of candidate percentages can be used, for instance by incrementing in different amounts or having finer increments within certain ranges (e.g., increment by 0.5% until 10%, then increment by 1% until 90%) and candidate percentages can be iterated in any order.

At block 607, the trainer sets the bottom candidate percentage of credibility vectors of unlabeled samples to zero vectors. The trainer orders the credibility vectors for unlabeled samples by corresponding weights and sets the bottom candidate percentage of the credibility vectors to zero vectors. This has the effect of zeroing out the least certain/credible vectors so that they can be refined at later iterations of updating credibility vectors. Additionally, the trainer generates a probability distribution P representing certainty of each class across credibility vectors with bottom candidate percentage set to zero vectors. This probability distribution is generated in the same manner as Q but instead applied to the credibility vectors with the bottom candidate percentage set to zero vectors, for instance according to the equation at line 6 of Algorithm 3.

At block 611, the trainer quantifies the impact on the distribution of the credibility vectors of setting the bottom candidate percentage to zero vectors. The trainer computes the KL divergence from distribution P to distribution Q. This KL divergence is a statistical distance from P to Q in the space of probability distributions. It quantifies the effect of zeroing out the bottom candidate percentage of credibility vectors. Rather than simply having a fixed subsampling percentage, this method determines a subsampling rate according to probability distribution metrics to determine impact of changes between the original and subsampled credibility vectors. Note that the KL divergence grows with increasing candidate percentage because an increasing amount of the credibility vectors are set to zero vectors. In a first iteration when the candidate percentage is 0, these operations can be skipped because the KL divergence is 0 (with no subsampling the distributions P and Q are the same).

At block 613, the trainer determines whether there is an additional candidate percentage (i.e., whether the current candidate percentage is less than the maximal percentage). If there is an additional candidate percentage, operational flow returns to block 605. Otherwise, operational flow proceeds to block 615.

At block 615, the trainer sets the subsampling percentage p to be the largest candidate percentage with impact below an impact threshold. Essentially, this is the largest amount of credibility vectors that can be zeroed without significantly affecting certainty information in the credibility vectors. For instance, the impact threshold can be a KL divergence value representing maximum acceptable divergence between probability distributions P and Q. The threshold KL divergence, at the first iteration through Algorithm 3, can be a fixed value tuned to avoid over subsampling (resulting in information loss) and under subsampling (propagating errors from inaccurate credibility vectors), e.g., 0.01 at a first iteration through Algorithm 3.

At block 617, the trainer sets the maximal percentage to be the subsampling percentage p and scales the impact threshold. For instance, the trainer can scale the impact threshold (KL divergence threshold in the given examples) by a factor of 10 so that, in the above example, the threshold is 0.001 at a second iteration of Algorithm 3.

At block 619, the trainer returns the normalized credibility vectors with the bottom p % of credibility vectors for unlabeled samples set to zero vectors as the subsampled credibility vectors. The bottom p % are determined according to ordering by the previously computed weights that indicate certainty of credibility vectors.

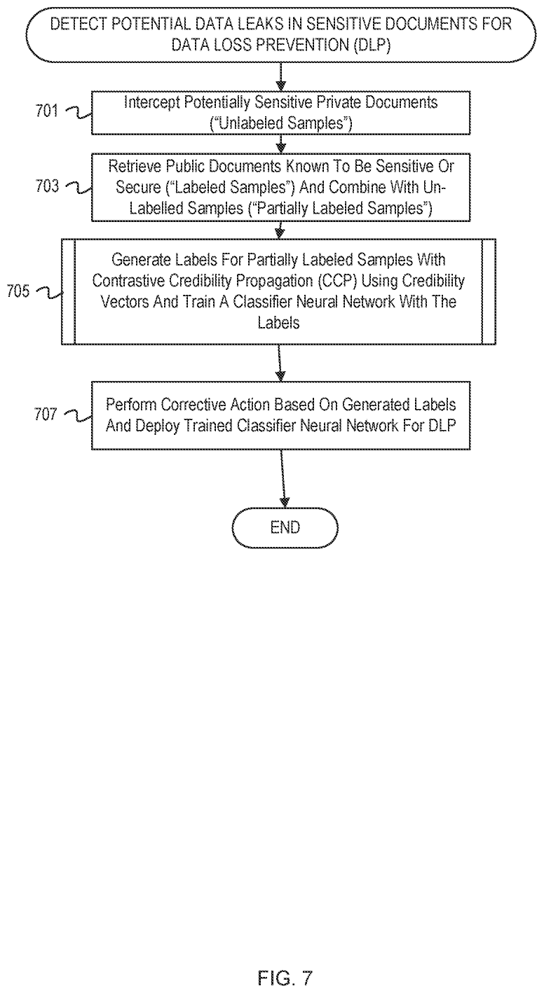

FIG. 7 is a flowchart of example operations for detecting potential data leaks in sensitive documents for DLP using a classifier trained with CCP using credibility vectors. At block 701, a firewall intercepts potentially sensitive documents (“unlabeled samples”). Each document is a text document comprising a sequence(s) of characters. The firewall can intercept the potentially sensitive documents across channels of communication and/or can detect potentially sensitive documents stored in databases at endpoint devices or in the cloud. The firewall monitors channels of communication and/or databases known to host and/or observe sensitive documents (e.g., email communications from endpoint devices, secure databases, etc.).

At block 703, a trainer retrieves public documents known to be sensitive or secure (“labeled samples”) and combines the labeled samples with unlabeled samples (“partially labeled samples”). The trainer can additionally retrieve private labeled samples (both sensitive and secure) previously labeled during DLP to add to the partially labeled samples. The public documents can be stored and queried by the trainer from public repositories on the Internet. While the labeled and unlabeled samples may have different underlying distributions due to different sources/contexts of those documents, techniques for CCP using credibility vectors disclosed herein minimize label errors arising from these differences.

At block 705, the trainer generates labels for the partially labeled samples with CCP using credibility vectors and a training a classifier neural network with the labels. The operations at block 705 are depicted in greater detail with reference to FIG. 3.

At block 707, the firewall performs corrective action based on the generated labels and deploys the trained classifier for DLP. For instance, for each sample (i.e., document) labeled as sensitive, the firewall can throttle or disconnect a corresponding channel of communication. The firewall can erase or add encryption to compromised databases storing sensitive documents. Corrective action can be based on threat levels of corresponding sensitive documents and the type/amount of data sensitive data contained therein. The firewall deploys the trained classifier neural network (“trained classifier”) for DLP to classify additional potentially sensitive documents. The trained classifier can be deployed to be oblivious to contents of the documents themselves, and documents can be held private/sensitive from any users or channels of communication until classification occurs. In some instances, private documents are obfuscated/encrypted during training so that the classifier learns to classify the documents without the trainer or classifier directly observing/learning contents of the documents. Alternatively, the classifier can be trained on private documents that are separate from the 3^{rd} party, so that documents at the 3^{rd} party are never exposed during training.

### Variations

Architecture of various neural networks herein can vary by implementation in terms of order, size, and type of layers and other neural networks besides those described herein are anticipated. The methodology for using credibility vectors in the context of contrastive credibility propagation for a semi-supervised labeling task applies beyond the particular implementation(s)/design choices, algorithms, choice of data transformations, and other details provided herein. Moreover, this methodology applies beyond semi-supervised learning of labels of text documents in DLP. For instance, CCP can be applied to vision tasks in semi-supervised learning.

Operations for updating, normalizing, clipping, subsampling, etc. credibility vectors are applied throughout to credibility vectors for unlabeled samples. Alternatively, these operations can be applied to credibility vectors for both labeled and unlabeled samples. Using CCP on all of the credibility vectors can correct previously incorrect labels for labeled samples when the labels are unreliable.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 507 can be performed in parallel or concurrently across classes for a given sample/transformation. Subsampling as depicted in FIG. 6 can be omitted in simpler implementations. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine- readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

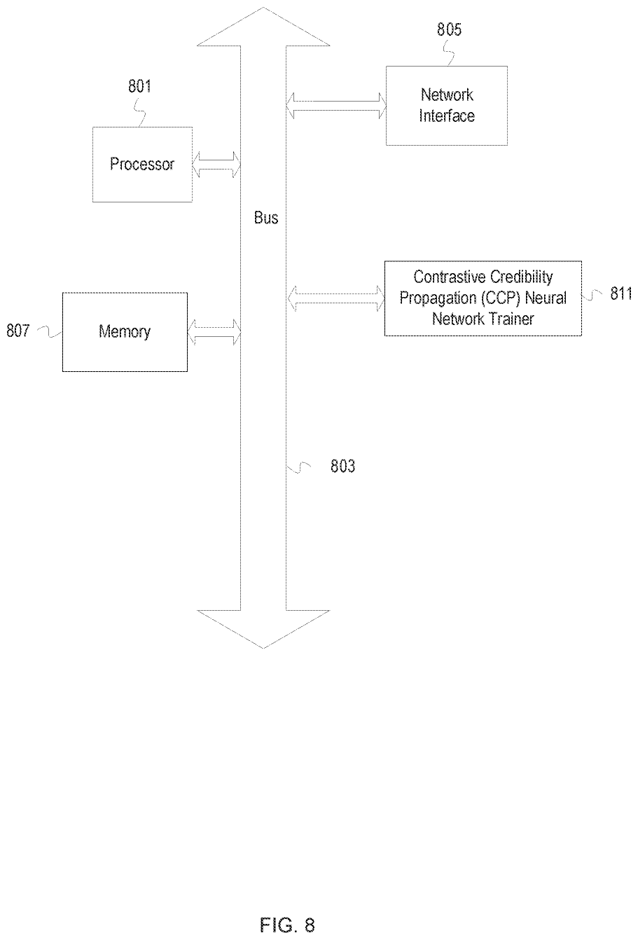

FIG. 8 depicts an example computer system with a CCP neural network trainer. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a CCP neural network trainer (“trainer”) 811. The trainer 811 can train a representation neural network to learn credibility vectors for partially labeled samples according to a loss function which incorporates the credibility vectors as well as representations of the samples generated by the representation neural network. The trainer 811 can, using the credibility vectors as soft labels, train a classifier neural network to generate labels for unlabeled samples in the partially labeled samples. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
training a first neural network to generate soft labels for a plurality of partially labeled samples based, at least in part, on credibility vectors for each of the plurality of partially labeled samples indicating certainty of class assignment, wherein training the first neural network comprises, for each epoch in a plurality of epochs,
applying, for each of the plurality of partially labeled samples, one or more of a plurality of transformations to generate a plurality of transformed samples;
inputting the transformed samples into a first neural network to generate a plurality of representations for the transformed samples;
updating credibility vectors corresponding to unlabeled samples in plurality of partially labeled samples based, at least in part, on the plurality of representations;
training the first neural network based, at least in part, on the plurality of representations and the updated credibility vectors; and
averaging, for each unlabeled sample of the plurality of partially labeled samples, corresponding updated credibility vectors across the plurality of epochs; and
determining labels for the unlabeled samples of the plurality of partially labeled samples based, at least in part, on the averaged credibility vectors.

2. The method of claim 1, further comprising, subsequent to averaging corresponding updated credibility vectors across the plurality of epochs and prior to determining labels, for each unlabeled sample of the plurality of partially labeled samples:
normalizing the averaged credibility vectors by their respective maximal entries; and
clipping the normalized credibility vectors to have entry values between one and zero.

3. The method of claim 2, further comprising training a second neural network to predict labels for additional samples based, at least in part, on the plurality of partially labeled samples and the clipped credibility vectors.

4. The method of claim 3, wherein the second neural network is trained on a cross-entropy loss function applied to the clipped credibility vectors as soft labels and outputs of the second neural network from inputting the plurality of partially labeled samples.

5. The method of claim 2, further comprising, subsequent to clipping the normalized credibility vectors and prior to determining labels:
determining a percentage of the clipped credibility vectors to subsample; and
at least one of setting a subset of the clipped credibility vectors according to the percentage to zero vectors and discarding the subset of the clipped credibility vectors.

6. The method of claim 5, wherein determining the percentage of the clipped credibility vectors to subsample comprises:
for each candidate percentage of a set of candidate percentages,
setting a subset of the clipped credibility vectors to zero vectors according to the candidate percentage to generate subsampled credibility vectors;
converting the clipped credibility vectors and the subsampled credibility vectors into a first probability distribution and a second probability distribution, respectively; and
computing a probability distribution distance from the second probability distribution to the first probability distribution; and
determining the percentage of the clipped credibility vectors as a candidate percentage in the set of candidate percentages having a maximal corresponding probability distribution distance below a threshold probability distribution distance.

7. The method of claim 5, further comprising:
computing weights for the clipped credibility vectors as maximal entries of corresponding averaged credibility vectors; and
determining the subset of the clipped credibility vectors as a subset with lowest computed weights according to the percentage.

8. The method of claim 1, wherein updating the credibility vectors comprises:
for each credibility vector and each transformation of the one or more of the plurality of transformations applied to a corresponding sample,
updating each entry of the credibility vector according to proximity of a representation of the sample corresponding to the credibility vector with the transformation applied to representations of other samples with transformations in the plurality of transformations applied; and
normalizing entries of each updated credibility vector by corresponding maximal entries; and
averaging the normalized credibility vectors for each corresponding sample across the one or more of the plurality of transformations.

9. The method of claim 1, wherein training the first neural network comprises backpropagating loss through layers of the first neural network based on a loss function applied to the plurality of representations and the updated credibility vectors.

10. A non-transitory, machine-readable medium having program code stored thereon, the program code comprising instructions to:
train a first model to learn an embedding space for representations for a plurality of samples that includes labeled and unlabeled samples and generate credibility vectors for the plurality of samples, wherein a credibility vector comprises an entry for each possible class with the entry having a certainty value indicating certainty of membership in the class of the entry and wherein the instructions to train the first model and generate the credibility vectors comprise instructions to,
for each epoch of each training iteration, update the credibility vectors of the unlabeled samples based on similarity of corresponding representations;
compute loss with a contrastive learning loss function that uses the credibility vectors of the plurality of samples;
for each training iteration, average the credibility vectors of the unlabeled samples across epochs of the training iteration; and
if training has not completed, indicate the averaged credibility vectors as credibility vectors for a succeeding training iteration; and
after completion of training the first model, indicate the averaged credibility vectors of unlabeled samples as soft labels for the unlabeled samples.

11. The machine-readable media of claim 10, wherein the program code further comprises instructions to:
train a second model to predict labels for additional samples based, at least in part, on the soft labels, wherein the soft labels are used to compute loss in training the second model.

12. The machine-readable media of claim 10, wherein the program code further comprises instructions to:
initialize the credibility vectors of the labeled samples according to corresponding labels; and
initialize the credibility vectors of the unlabeled samples to zero vectors.

13. The machine-readable media of claim 10, wherein the program code further comprises instructions to, for each training iteration, normalize each of the averaged credibility vectors with respect to maximal certainty values.

14. The machine-readable media of claim 13, wherein the program code further comprises instructions to, for each training iteration, subsample the normalized credibility vectors and set the subsample of normalized credibility vectors to zero vectors.

15. The machine-readable media of claim 14, wherein the program code further comprises instructions to, for each training iteration, determine a subsampling rate for a succeeding training iteration, wherein the instructions to determine the subsampling rate comprise instructions to determine a maximum of multiple candidate subsampling rates for zero setting the normalized credibility vectors that yields a greatest overall impact on probability distribution of the normalized credibility vectors below a threshold impact.

16. An apparatus comprising:
a processor; and
a machine-readable medium having instructions stored thereon that are executable by the processor to cause the apparatus to,
train a first neural network to generate representations of a plurality of partially labeled samples in tandem with updating credibility vectors indicating certainty of class assignment for each of the plurality of partially labeled samples, wherein the instructions executable by the processor to cause the apparatus to train the first neural network comprise instructions to, for each of a plurality of training epochs,
input transformations the plurality of partially labeled samples into the first neural network to generate representations of the plurality of partially labeled samples;
update credibility vectors based on similarity of the generated representations; and
update the first neural network according to a loss function on the generated representations and updated credibility vectors; and
generate soft labels based, at least in part, on credibility vectors updated across subsets of the plurality of partially labeled samples; and
train a second neural network to predict labels for additional samples based, at least in part, on the soft labels and the plurality of partially labeled samples.

17. The apparatus of claim 16, wherein the first neural network comprises third neural network and a first projection head, wherein the second neural network comprises the third neural network and a second projection head.

18. The apparatus of claim 17, wherein the machine-readable medium further has stored thereon instructions executable by the processor to cause the apparatus to initialize internal parameters of the third neural network prior to training the second neural network to generate labels for the plurality of partially labeled samples.

19. The apparatus of claim 16, wherein the machine-readable medium further has stored thereon instructions executable by the processor to cause the apparatus to average credibility vectors updated across the plurality of training epochs.

20. The apparatus of claim 19, wherein the machine-readable medium further has stored thereon instructions executable by the processor to cause the apparatus to at least one of normalize and clip the averaged credibility vectors.

21. The apparatus of claim 16, wherein the machine-readable medium further has stored thereon instructions executable by the processor to cause the apparatus to, prior to generating the soft labels, subsample the credibility vectors.

22. The apparatus of claim 21, wherein the machine-readable medium further has stored thereon instructions executable by the processor to cause the apparatus to determine a subsampling rate for subsampling the credibility vectors based, at least in part, on changes in probability distribution of the credibility vectors by zeroing the credibility vectors at each of one or more candidate subsampling rates.
